(19) United States
(12) Patent Application Publication
(10) Pub. No.: US 2010/0215488 A1
(43) Pub. Date: Aug. 26, 2010

(54) FLUID FLOW ENERGY CONCENTRATOR

(75) Inventor: Stephen P. Santoro, Rochester Hills, MI (US)

Correspondence Address: Brinks Hofer Gilson & Lione/Ann Arbor, 524 South Main Street, Suite 200, Ann Arbor, MI, 48104, US

(73) Assignee: Santoro Wind Harvestor Inc., Rochester Hills, MI (US)

(21) Appl. No.: 12/391,713

(22) Filed: Feb. 24, 2009

(51) Int. Cl. F03D 11/00

(52) U.S. Cl. 415/208.1

(57) ABSTRACT

An energy conversion system for converting energy of naturally occurring fluid flow into output power. The energy conversion system includes an accelerator plate that has a leading edge and an upper surface that is substantially linearly inclined from the leading edge and transitions into a gradually increasing inclined shape so as to receive a fluid flow and form a vortex at a rear portion of the accelerator plate and a turbine positioned at the rear of the accelerator to rotate in the vortex created by the accelerator plate. The cross-sectional shape of the accelerator plate has a duckbill shape which causes the fluid flow to increase up to five times and before turbulence is created and directs the increased air flow onto the blades of the turbine.

### TECHNICAL FIELD

The present invention relates to wind and fluid powered kinetic devices and more particularly to wind and fluid powered generators. More specifically, the present invention relates to methods and devices to accelerate natural wind and fluid flow for increasing the output of wind and fluid powered kinetic devices, including wind and fluid powered generators.

### BACKGROUND ART

Wind is a well known source of energy, has a limitless supply and is available and dependable substantially all of the time. The average speed and force of wind at any given location can be predicted with reasonable accuracy. However, as a source of harvested energy, wind has not been utilized to its fullest extent.

Earlier wind machines such as windmills employ principles and practices in their construction and operation which are quite inefficient. These prior machines have primarily depended upon restricting natural air flow by causing the air flow to impinge upon various shaped blades.

It has long been recognized that a greater amount of energy can be produced by increasing the effective velocity of the wind at the rotor or turbine of a wind machine to thereby increase the output power or permit smaller rotors for a given output power. This, of course, is one of the main motives in selecting a site having airfoil type topography, or topography providing a diffuser effect; hopefully such conditions cause an effective increase in local wind velocity. Proposals have also been made to use natural or constructed rotor shrouds to increase the free stream velocity in the region of the turbine. Utilization of existing or modified terrain for such purposes drastically limits site availability, can represent a costly undertaking, and tends to make wind directions critical.

Artificially constructed shrouds which have been proposed appear to involve massive dimensions with all of the complications associated with large, heavy movable structures. Various proposals are also found in the patent literature. These include arrangements employing bell mouth inlets, deflecting surfaces, vanes and the like to introduce diffusion or deflection effects.

Most small wind turbines do not operate well in the low wind areas with an average wind speed of 8mph or less. Typical vertical wind turbine designs produce resistance and loss of efficiency as they cut back through the oncoming wind (on the leeward side). Most alternate designs are larger units, 20 to 30 feet high, and require installation on a pole to access higher wind speeds.

The present invention provides methods and devices to accelerate natural wind and fluid flow for increasing the output of wind and fluid powered kinetic devices, including wind and fluid powered generators. The methods and devices of the present invention allow for the use of small wind turbines in areas where their use would otherwise be severely inefficient.

### DISCLOSURE OF THE INVENTION

According to various features, characteristics and embodiments of the present invention which will become apparent as the description thereof proceeds, the present invention provides an energy conversion system for converting energy of naturally occurring fluid flow into output power which system includes:

an accelerator plate that has a leading edge and an upper surface that is substantially linearly inclined from the leading edge and transitions into a gradually increasing inclined shape so as to receive a fluid flow and form a vortex at a rear portion of the accelerator plate; and

a turbine positioned at the rear of the accelerator to rotate in the vortex created by the accelerator plate.

The present invention further provides an energy conversion system for converting energy of naturally occurring fluid flow into output power which system includes:

an accelerator plate that has a leading edge and an upper surface that is substantially linearly inclined from the leading edge and transitions into a gradually increasing inclined shape so as to receive a fluid flow and form a vortex at a rear portion of the accelerator plate;

a turbine positioned at the rear of the accelerator to rotate in the vortex created by the accelerator plate; and

at least one directional fin that interacts with the fluid flow and keeps the leading edge of the accelerator plate facing into the fluid flow.

The present invention also provides a method of converting a natural source of fluid flow into output power which method involves:

providing an energy conversion system for converting energy of naturally occurring fluid flow into output power, said system comprising:
an accelerator plate that has a leading edge and an upper surface that is substantially linearly inclined from the leading edge and transitions into a gradually increasing inclined shape so as to receive a fluid flow and form a vortex at a rear portion of the accelerator plate; and
a turbine positioned at the rear of the accelerator to rotate in the vortex created by the accelerator plate;

positioning the energy conversion system in a natural fluid flow; and

allowing the turbine to convert the natural source of fluid flow into output power.

### BRIEF DESCRIPTION OF DRAWINGS

The present invention will be described with reference to the attached drawings which are given as non-limiting examples only, in which:

FIG. 1 is a diagram that depicts how air flows around a spherical shaped article.

FIG. 2 is a diagram that depicts how air flows around an inclined article.

FIGS. 3a-3d are diagrams that depict how air flow is directed and moved along an accelerator plate according to the present invention.

FIG. 4 is a cross sectional diagram of a turbine having blades of a different configuration according to the present invention.

FIG. 5 is a front perspective view of an accelerator plate according to the present invention in combination with a turbine.

FIG. 6 is a side-by-side comparison of a conventional turbine wind generator and a wind powered generator according to the present invention.

FIG. 7 is a prospective view of a wind powered generator according to one embodiment of the present invention which is horizontally mounted to a supporting pole.

FIG. 8 is bottom perspective view of a wind powered generator according to another embodiment of the present invention which is horizontally mounted to a supporting pole.

FIG. 9 is a front perspective view of the wind powered generator of FIG. 8.

FIG. 10 is a top perspective view of the wind powered generator of FIG. 8 which includes a supporting structure.

FIGS. 11a-11c are drawings that depict further non-limiting examples of directional fin shapes according to further embodiments of the present invention.

### BEST MODE FOR CARRYING OUT THE INVENTION

The present invention relates to wind and fluid powered kinetic devices and more particularly to wind and fluid powered generators. More specifically, the present invention relates to methods and devices to accelerate natural wind and fluid flow for increasing the output of wind and fluid powered kinetic devices, including wind and fluid powered generators.

The present invention provides a unique accelerator plate design that can accelerate natural wind and fluid flow for increasing the output of wind and fluid powered kinetic devices, including wind and fluid powered generators. The accelerator plate of the present invention has a cross sectional shape similar to that of a duck's head and bill (referred to herein as a “duckbill shape”) that increases wind flow speed over face of the accelerator plate. The accelerator plate increases the flow of air up to a point before turbulent effects are created and then directs the high speed air into a low pressure area where turbine blades are provided. The shape and contour of the accelerator plate creates both the increase in air flow and the low pressure area.

The accelerator plates of the present invention can be used in combination with conventional turbines as well as with turbines having blades that are shaped according to the present invention to take maximum advantage of the increased air flow.

The fluid powered generators, which include the accelerator plates of the present invention in combination with turbines, can be oriented vertically or horizontally in a fluid flow or any orientation between vertical and horizontal.

Reference herein to fluid powered generators is made to encompass harvesting energy from both liquid and gaseous fluid flows, such as water flow and air flow. Reference herein to features of wind powered generators is to be interpreted as being applicable to generators that can harvest energy from liquid flow.

The fluid powered generators of the present invention can be mounted stationary on various structures, including poles. In addition, the fluid powered generators can be mounted to moving structures such as land, marine or aeronautic vehicles. Further the accelerator plate of the fluid powered generators of the present invention can be incorporated into architectural structures, including buildings, sculptures, etc.

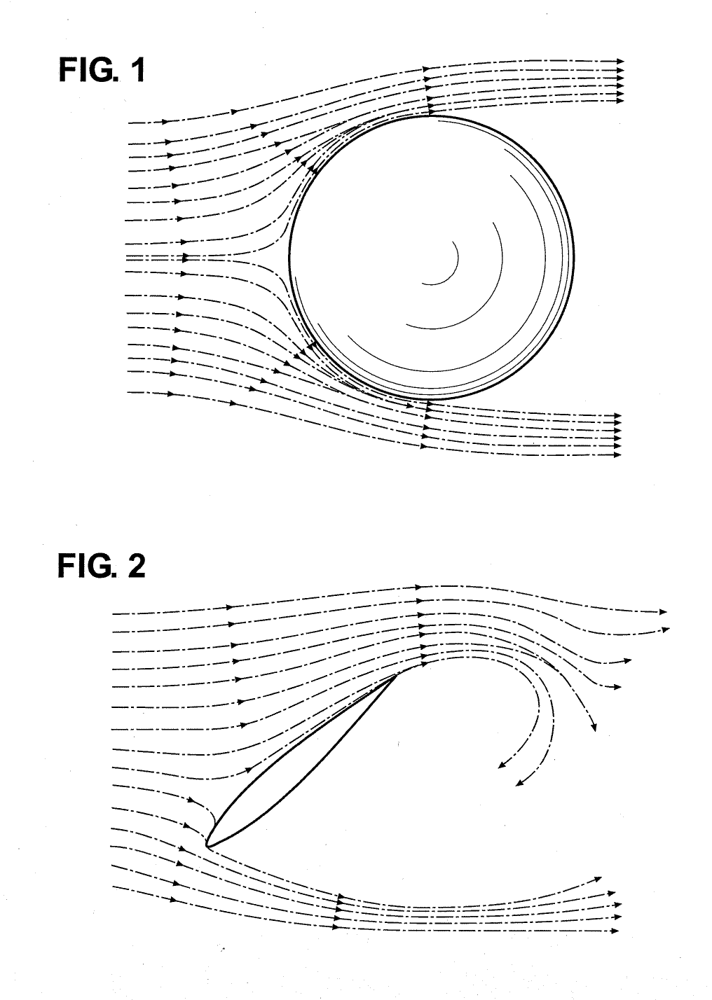

FIG. 1 is a diagram that depicts how air flows around a spherical shaped article. As shown in FIG. 1, there are five marked streamlines of air flow upstream of the spherical article which squeezed together so as to appear as a single merged streamline of air flow.

FIG. 2 is a diagram that depicts how air flows around an inclined article. The inclined article in FIG. 2 is a wing (in cross section). As shown, the streamlines are squeezed together as they move upward along the upper leading surface of the wing and form a turbulent area behind the wing at a high enough Reynolds number.

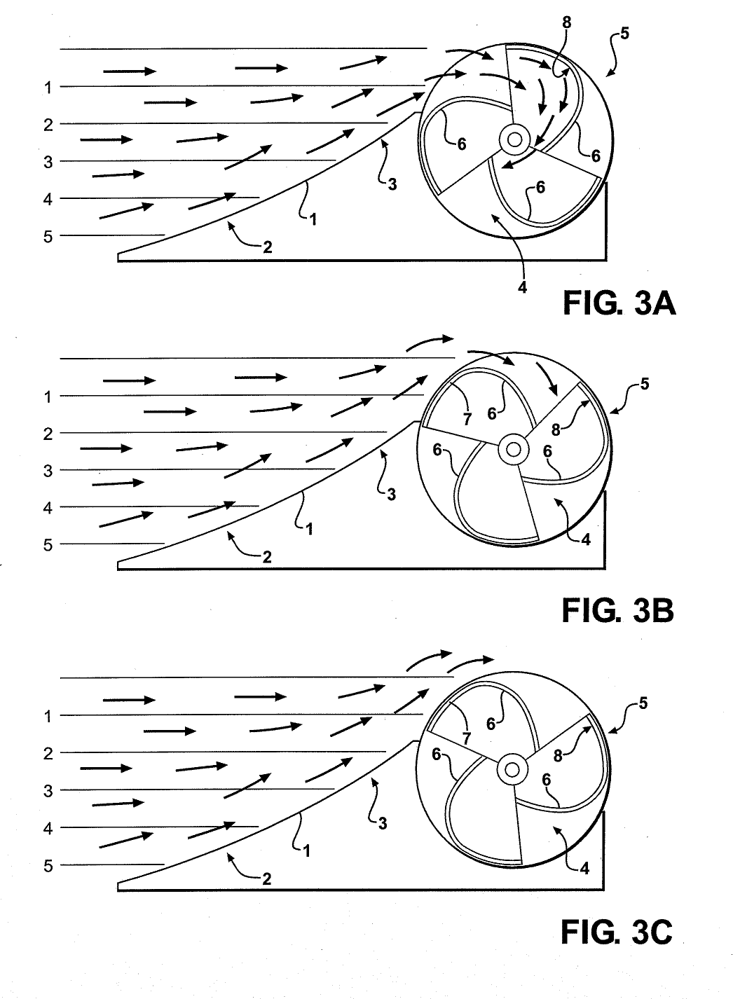

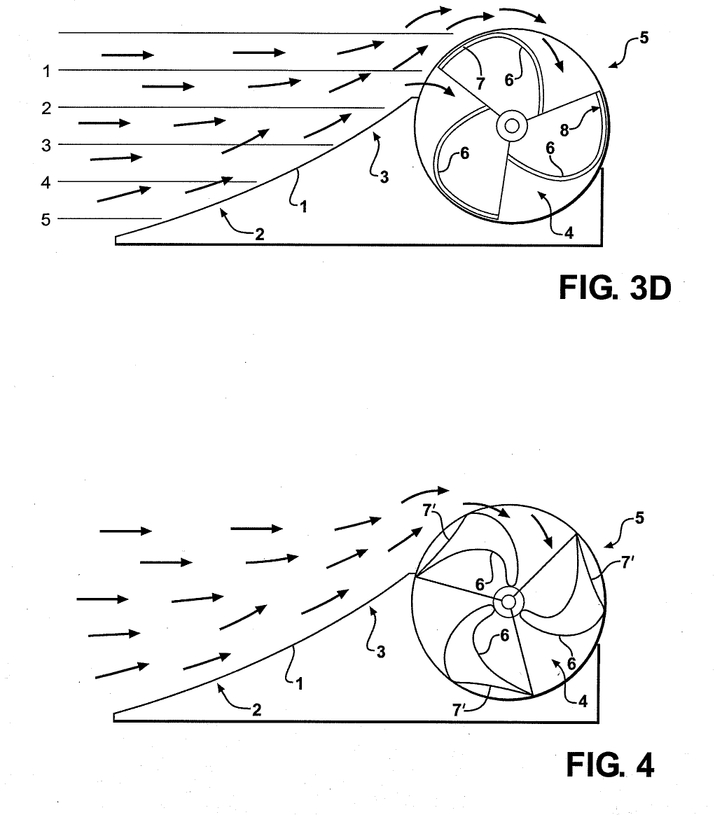

FIGS. 3a-3d are diagrams that depict how air flow is directed and moved along an accelerator plate according to the present invention. The upper shape of the accelerator plate 1 shown in FIGS. 3a-3d has been designed to replicate the streamlines that flow over the leading upper surface of the inclined wing in FIG. 2. In this regard, the leading portion 2 of the upper surface of the accelerator plate 1 is substantially linearly inclined upward, while the rear portion 3 of the upper surface of the accelerator plate 1 has an inclined shape that gradually increases. This overall shape is referred herein to as a “duckbill” since it has the general shape of the head and beak of a duck.

At the rear portion 3 of the accelerator plate 1 wherein the streamlines will curve downward as depicted in FIG. 2, a cavity 4 is provided to house a turbine 5 having a plurality of turbine blades 6 as depicted. As shown in FIG. 3a-3d, the turbine 5 is centered and the turbine blades 6 are shaped so that as the turbine rotates (clockwise in FIGS. 3a-3d), the outer leading surfaces 7 of the turbine blades 6 continue the increasing inclined shape of the rear portion 3 of the upper surface of the accelerator plate 1 (See FIGS. 3b and 3c) and the outer following surfaces 8 of the turbine blades 6 capture the naturally downward curving portions of the streamlines (See FIGS. 3a, 3b and 3d). As shown in FIGS. 3a-3d, the turbine 5 is positioned so that a line extending from the rear of the surface of the accelerator plate 1 corresponds to a chord that is located at about 60% outward on a radius from the center of the turbine 5. This orientation was determined to provide a maximum effect to rotate the turbine 5.

It can thus be understood that the accelerator plate 1 of the present invention when combined with a turbine 5, conforms to the natural flow of air about and around an inclined article which causes the wind speed to increase by a factor of up to 5 times the ambient or natural flow rate. After the speed of the wind is built up and increased by the accelerator plate 1, the high speed flow of air is allowed to flow into the low pressure area where the turbine 5 is positioned, with blades that are designed to alternately (as they rotate) enhance the speed of the air and capture the high speed flow or air. The overall configuration of the accelerator plate 1 is designed to reduce or eliminate turbulent air flow as is the position of the turbine 5 and the configuration of the turbine blades 6. Eliminating turbulence effects helps optimize the efficiency of the overall system.

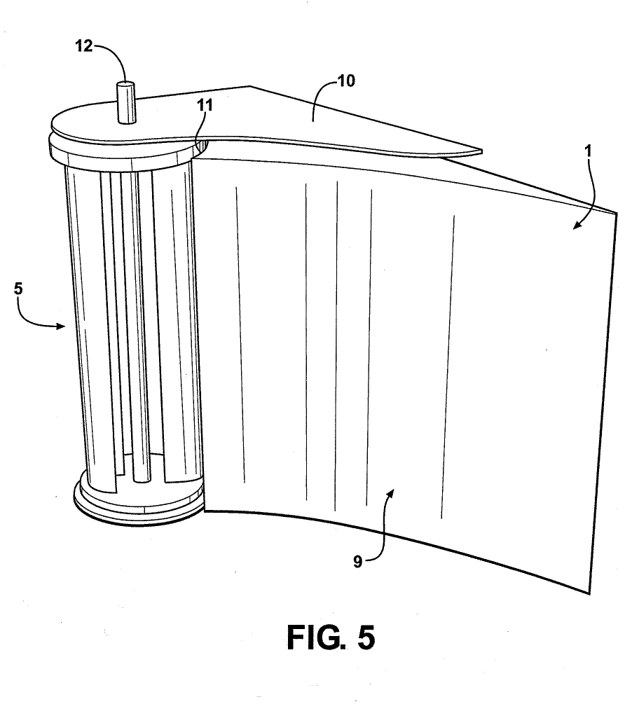

FIG. 4 is a cross sectional diagram of a turbine having blades of a different configuration according to the present invention. The turbine blades 6 shown in FIG. 5 have outer leading surfaces 7′ that have a concave shape that even more dramatically continue and increase the increasing inclined shape of the rear portion 3 of the upper surface of the accelerator plate 1. As in each of the embodiments, the inner most edges of the turbine blades 6 are radially spaced outward from the axial center of the turbine 5.

It is noted that in FIGS. 3a-3d and 4 the turbine 5 is depicted as having three blades 6. In other embodiments, the turbine 5 can have any number of blades 6, including three or more.

FIG. 5 is a front perspective view of an accelerator plate according to the present invention in combination with a turbine. As depicted in FIG. 5 the top surface 9 of the accelerator plate 1 is a continuous surface that, in the illustrated embodiment is supported by side walls or panels 10. The accelerator plate 1 is coupled to the turbine 5 by side walls panels 10 which are shown as being planer structures that are configured to the shape of the circular ends of the turbine 5 and at least a portion of the sides of the accelerator plate 1. In alternative embodiments the accelerator plate 1 can be coupled to the turbine 5 by any suitable frame or bracket structure. The surface 11 of the accelerator plate 1 which surrounds the turbine 5 is also a continuous surface. The turbine 5 is not particularly unique other than the shape of the turbine blades 6 as discussed herein. The shaft 12 of the turbine 5 extends out from either one or both of the side panels 10 and can be coupled to a suitable generator or other rotary driven device. In this regard, although particularly suitable for power generation, the systems of the present invention can also be used to drive various rotary devices. Alternatively, the rotor and stator of a generator may be incorporated on the ends of the turbine 5 within the turbine housing as discussed below.

The rear or underside of the accelerator plate 1 can be covered or enclosed or open or hollow with one or more suitable structural cross brace(s) that extend between side walls 10. Making the rear or underside of the accelerator plate 1 hollow will reduce the overall weight of the device. It is also possible to coupled two accelerator plate/turbine combinations together at their bottoms.

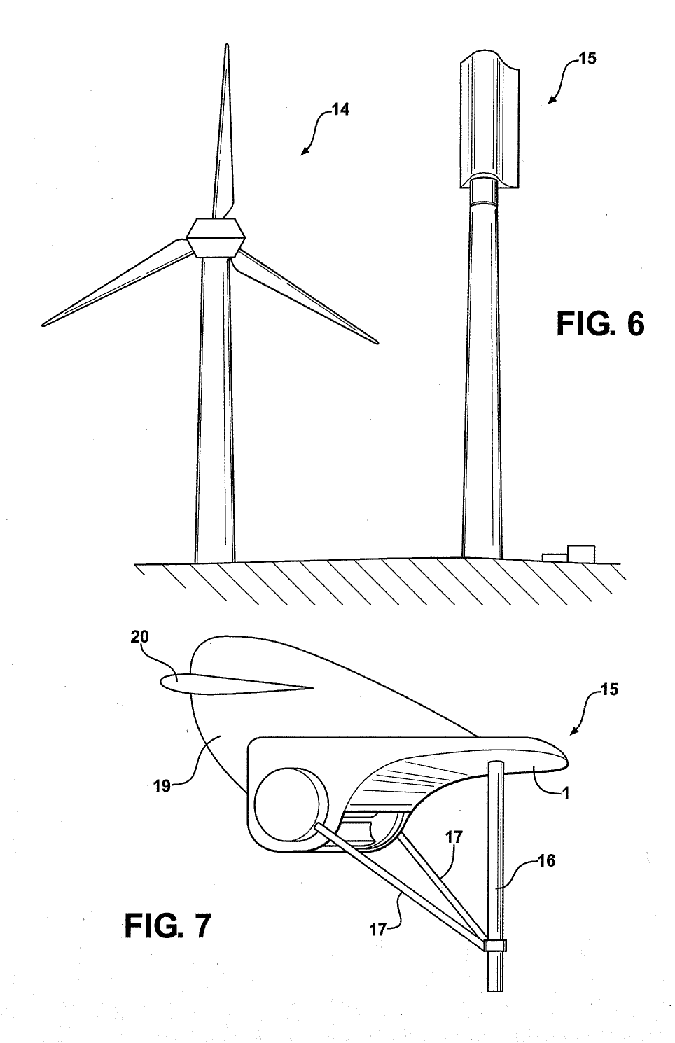

FIG. 6 is a side-by-side comparison of a conventional turbine wind generator and a wind powered generator according to the present invention. What stands out in FIG. 6 is that whereas the conventional turbine wind generator 14 has a large profile that requires significant spacing apart of such wind generators in a power generating area or field, the wind powered generator 15 of the present invention has a significantly smaller profile which will allow many more to be used together in a power generating area or field. Further, the large blades of the conventional turbine wind generator 14 which are know to rotate dangerously and for example harm birds and other foul are completely eliminated in the wind powered generators 15 of the present invention.

The wind powered generator 15 of the present invention can be mounted either vertical or horizontal or at any convenient angle for use. Since the leading edge of the accelerator plates 1 needs to be pointed into the oncoming wind, the wind powered generators of the present invention are provided with, in addition to the accelerator plates 1 and turbines 5, various directional positioning structures, non-limiting examples of which will be discussed hereafter.

FIG. 7 is a prospective view of a wind powered generator according to one embodiment of the present invention which is horizontally mounted to a supporting pole. In FIG. 7 the wind powered generator 15 is mounted to supporting pole 16 in a manner that allows the wind powered generator 15 to rotate about the supporting pole 16 for purposes of allowing the leading edge of the accelerator plate 1 to be pointed into the oncoming wind as the wind may change directions. In the embodiment of the invention shown in FIG. 7, the supporting pole 16 extend through a front portion of the accelerator plate 1 and two side support braces 17 couple the opposite sides 18 of the turbine 5 (or turbine housing) to the supporting pole 16 for rotary movement about the supporting pole 16. At the top of the accelerator plate 1 a directional fin 19 extends and is provided with horizontal stabilizers 20. This directional fin 19 catches the moving air flow and aligns the wind power generator so that the edge of the accelerator plate 1 to be pointed into the oncoming wind.

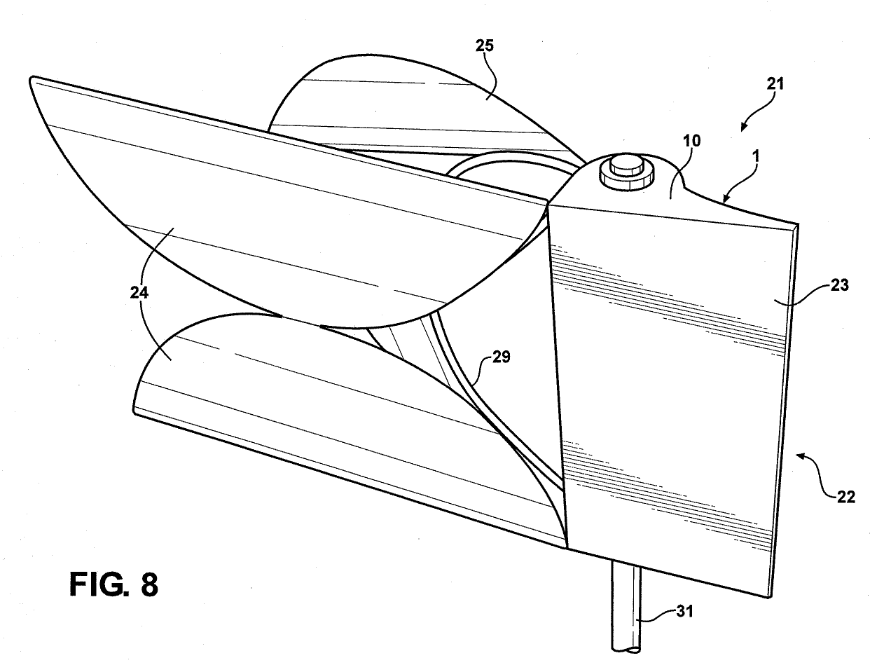

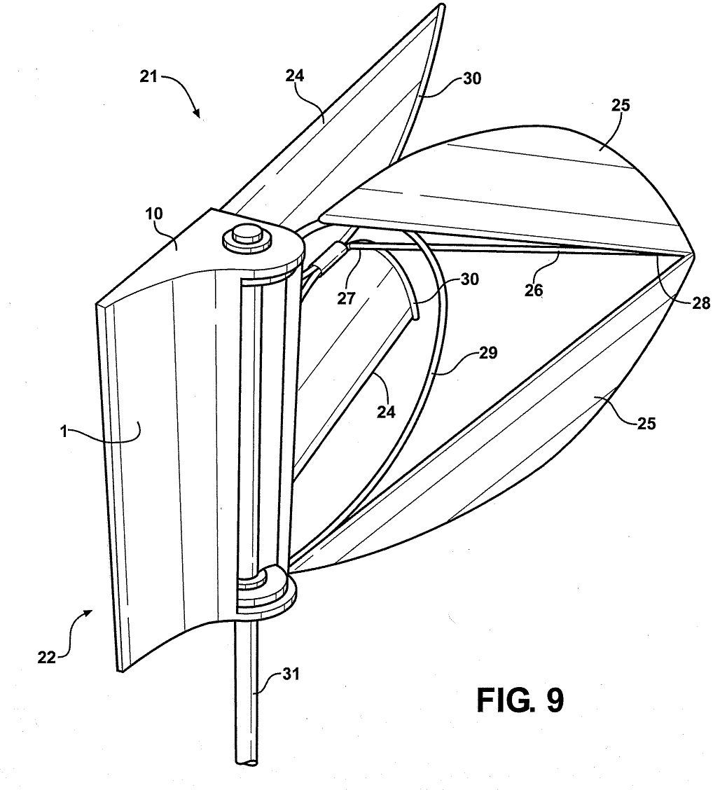

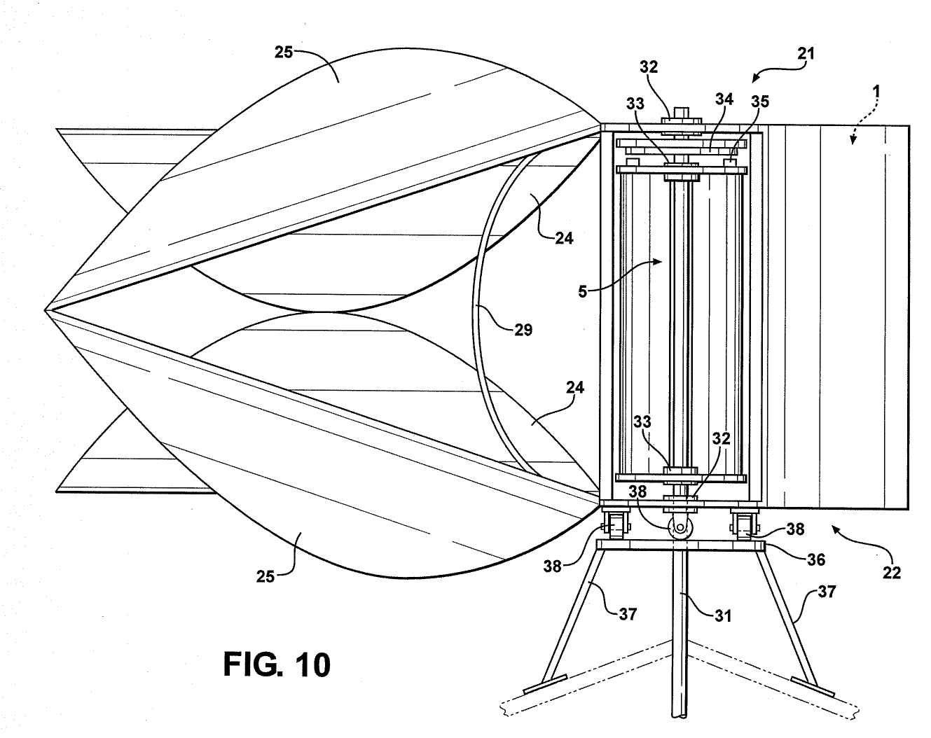

FIG. 8 is bottom perspective view of a wind powered generator according to another embodiment of the present invention which is horizontally mounted to a supporting pole. FIG. 9 is a front perspective view of the wind powered generator of FIG. 8. FIG. 10 is a top perspective view of the wind powered generator of FIG. 8 which includes a supporting structure.

The wind powered generator 21 depicted in FIGS. 8-10 includes accelerator plate 1 and turbine 5 which are similar to the embodiments of the invention discussed above. In this embodiment the accelerator plate 1 is configured into a housing structure 22 that includes side walls or panels 10 and a bottom wall or panel 23. Ideally the overall shape of the housing should be somewhat aerodynamic for purposes of providing a low wind resistance while also providing for the air acceleration to rotate turbine 5.

In the embodiment of the invention depicted in FIGS. 8-10 directional fins are provided which include at least one lower directional fin 24 (two shown) that extends rearward from a lower portion of turbine housing and at least one upper directional fin 25 (two shown) that extends rearward from a lower portion of turbine housing 22. Here the reference to “lower” and “lower” are made in reference to the lower surface or bottom 23 of the turbine housing 22. The lower directional fin(s) 24 have surfaces that are substantially coplanar with the lower surface or bottom 23 of the turbine housing. The upper directional fin(s) 25 have surfaces that are inclined upward from the rear of the turbine housing 22 at an angle of from about 45° to about 75°, and preferably from about 55° to about 65° and more preferably about 60°. A plane which is coplanar with the lower directional fins 24 and a plane which is coplanar with the upper directional fins 25 are at an angle of from about 45° to about 75°, and preferably from about 55° to about 65° and more preferably about 60° with one another. A horizontal brace 26 is shown as extending between the lower directional fin(s) 24 and the upper directional fins 25. The lower end 27 of the horizontal brace 26 is positioned near the center of the portion of the lower directional fin(s) 24 (where they are joined) as shown. The upper end 28 of the horizontal brace 26 is positioned near the rear edge of the upper directional fin(s) 25. There is also a curved brace 29 that extends between the upper directional fins 25 near the point where the upper directional fins 25 are coupled to the housing of the turbine 22.

In the depicted embodiment the there are two lower direction fins 24 and two upper directional fins 25. Each of the lower directional fins 24 and the upper directional fins 25 are bow-shaped structures that are formed by bent bow rods 30. The bow rods 30 can comprise permanently bend bow-shaped rods, or flexible rods that can be held in a bent configuration by a cables or similar elongate member(s). The surface structures of the lower and upper directional fins 24 and 25 can be fabrics that are stretched across the bow rods 30 and a cable or similar elongate member holding the bow rods in their bent configurations. The lower directional fins 24 and upper directional fins 25 shown in FIGS. 8-10 all have the same surface area as the bottom 23 of the turbine housing. The upper and lower directional fins 24 and 15 are configured to provide three points (“a,” “b” and “c”) which was determined to provide for stability of the unit.

The turbine housing 22 is mounted to supporting pole 31 in a manner that allows the turbine housing 22 to rotate about the supporting pole 31 for purposes of allowing the leading edge of the accelerator plate 1 to be pointed into the oncoming wind as the wind may change directions. For this purpose, bearings 32 are provided on opposite ends of the turbine housing 22 which allow the turbine housing 22 to rotate freely about the supporting pole 31. Additional bearings 33 are provided on opposite ends of the turbine 5 about support pole 31 within turbine housing 2 which allow the turbine 5 to freely rotate about support pole 31 within the turbine housing 22. Also shown in FIG. 10 is a conventional stator 34 which remains stationary with respect to the turbine 5 and conventional a rotor 35 mounted to the end of the turbine 5 and spaced apart from the stator. Such configurations of rotors/stators are generally known. Other embodiments of the invention can use the turbine 5 to indirectly rotate an rotor such as by a chain, gear or other mechanical linkage.

In the embodiment of the invention depicted in FIG. 10 an additional support plate 36 is provided below the turbine housing 2 and supported by support legs 37. The support plate 36 includes a central though-hole through which the support pole 31 passes. Rollers 38 coupled to the turbine housing 2 allow the turbine housing 22 to roll freely on support plate 36 while the turbine housing 22 rotates about support pole 31. It is to be understood that rollers 38 could be replaced by other types of bearings or bearing assemblies.

It is noted that although the axial center of the turbine 5 and the axial center of support pole 31 coincide in FIG. 10, in other embodiments of the invention the turbine housing 22 can be supported in a manner so that it rotates about an axis that is non-coaxial with the axial center of the turbine 5.

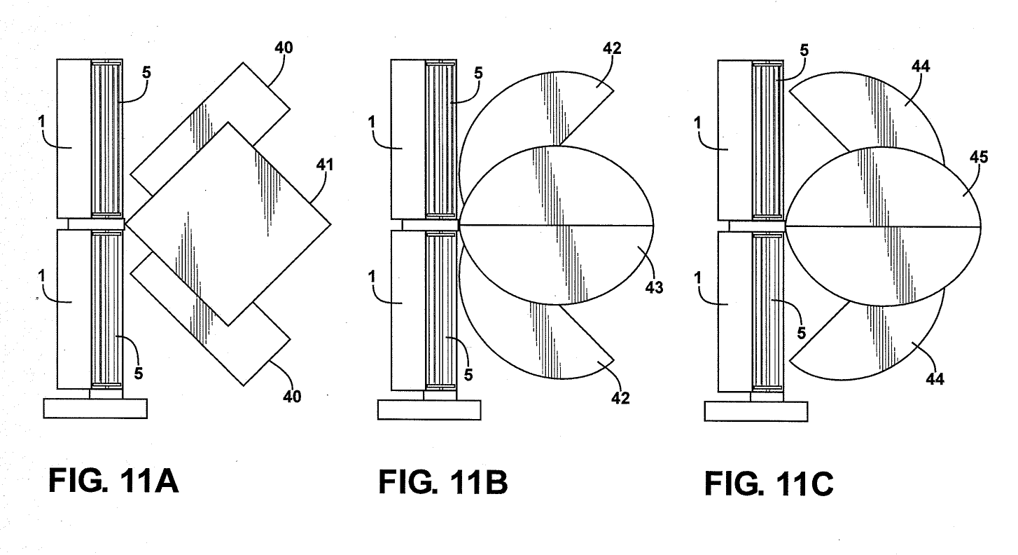

The present invention is not limited to the shape of the lower and upper directional fins 24 and 25 shown in FIGS. 8-10. FIGS. 11a-11b are further non-limiting examples of directional fin shapes according to further embodiments of the present invention.

In FIG. 11a the lower directional fins 40 are rectangular shaped and the upper directional fin 41 is square shaped. In FIG. 11b the lower directional fins 42 are semi-circular shaped and the upper directional fin 43 has an ovular shape. In FIG. 11c the lower directional fins 44 are semi-circular shaped and the upper directional fin 45 has an ovular shape. The difference between FIGS. 11b and 11c is that the orientation of the lower directional fins are reversed.

As an alternative to the use of directional fins, the wind powered generators of the present invention could be mounted with servo motors or other electronic mechanisms that automatically orient the accelerator plate 1 into the prevailing wind.

In further embodiments of the present invention, the accelerator plate or at least the upper surface of the accelerator plate could be linearly inclined along the entire length rather than have the curved shape that is depicted in the drawings.

Although the present invention has been described with reference to particular means, materials and embodiments, from the foregoing description, one skilled in the art can easily ascertain the essential characteristics of the present invention and various changes and modifications can be made to adapt the various uses and characteristics without departing from the spirit and scope of the present invention as described above or as set forth in the attached claims.

What is claimed is:

1. An energy conversion system for converting energy of naturally occurring fluid flow into output power, said system comprising:
an accelerator plate that has a leading edge and an upper surface that is substantially linearly inclined from the leading edge and transitions into a gradually increasing inclined shape so as to receive a fluid flow and form a vortex at a rear portion of the accelerator plate; and
a turbine positioned at the rear of the accelerator to rotate in the vortex created by the accelerator plate.

2. An energy conversion system for converting energy of naturally occurring fluid flow into output power, according to claim 1, wherein the accelerator plate has a lower substantially planar surface.

3. An energy conversion system for converting energy of naturally occurring fluid flow into output power according to claim 2, wherein the accelerator plate has a cross-sectional shape in the form of a duckbill.

4. An energy conversion system for converting energy of naturally occurring fluid flow into output power according to claim 1, wherein the turbine has a central axis that is parallel with the leading edge of the accelerator plate.

5. An energy conversion system for converting energy of naturally occurring fluid flow into output power according to claim 4, wherein the turbine has a plurality of curved blades that have inner edges that are radially spaced outward from the axial center of the turbine.

6. An energy conversion system for converting energy of naturally occurring fluid flow into output power according to claim 5, wherein the turbine blades have outer leading surfaces that have a concave shape.

7. An energy conversion system for converting energy of naturally occurring fluid flow into output power according to claim 1, further comprising a stator and a rotor.

8. An energy conversion system for converting energy of naturally occurring fluid flow into output power, said system comprising:
an accelerator plate that has a leading edge and an upper surface that is substantially linearly inclined from the leading edge and transitions into a gradually increasing inclined shape so as to receive a fluid flow and form a vortex at a rear portion of the accelerator plate;
a turbine positioned at the rear of the accelerator to rotate in the vortex created by the accelerator plate; and
at least one directional fin that interacts with the fluid flow and keeps the leading edge of the accelerator plate facing into the fluid flow.

9. An energy conversion system for converting energy of naturally occurring fluid flow into output power, according to claim 8, wherein the accelerator plate has a lower substantially planar surface.

10. An energy conversion system for converting energy of naturally occurring fluid flow into output power according to claim 9, wherein the accelerator plate has a cross-sectional shape in the form of a duckbill.

11. An energy conversion system for converting energy of naturally occurring fluid flow into output power according to claim 8, wherein the turbine has a central axis that is parallel with the leading edge of the accelerator plate.

12. An energy conversion system for converting energy of naturally occurring fluid flow into output power according to claim 11, wherein the turbine has a plurality of curved blades that have inner edges that are radially spaced outward from the axial center of the turbine.

13. An energy conversion system for converting energy of naturally occurring fluid flow into output power according to claim 12, wherein the turbine blades have outer leading surfaces that have a concave shape.

14. An energy conversion system for converting energy of naturally occurring fluid flow into output power according to claim 8, further comprising a stator and a rotor.

15. An energy conversion system for converting energy of naturally occurring fluid flow into output power according to claim 8, further comprising a support which supports the accelerator plate and turbine for vertical rotation.

16. An energy conversion system for converting energy of naturally occurring fluid flow into output power according to claim 15, wherein the support supports the turbine vertically.

17. An energy conversion system for converting energy of naturally occurring fluid flow into output power according to claim 15, wherein the support supports the turbine horizontally.

18. An energy conversion system for converting energy of naturally occurring fluid flow into output power according to claim 15, wherein the at least one directional fin comprises a plurality of directional fins.

19. A method of converting a natural source of fluid flow into output power which comprises:
providing an energy conversion system for converting energy of naturally occurring fluid flow into output power, said system comprising:
an accelerator plate that has a leading edge and an upper surface that is substantially linearly inclined from the leading edge and transitions into a gradually increasing inclined shape so as to receive a fluid flow and form a vortex at a rear portion of the accelerator plate; and
a turbine positioned at the rear of the accelerator to rotate in the vortex created by the accelerator plate;
positioning the energy conversion system in a natural fluid flow; and
allowing the turbine to convert the natural source of fluid flow into output power.

20. A method of converting a natural source of fluid flow into output power according to claim 19, wherein the output power comprises electrical power.
